(19) United States
(12) Patent Application Publication
(10) Pub. No.: US 2014/0087038 A1
(43) Pub. Date: Mar. 27, 2014

(54) AGGLOMERATION-PREVENTABLE SWEETENER COMPOSITION IN WHICH AGGLOMERATION IS PREVENTED, AND METHOD FOR PREPARING SAME

(71) Applicants: Young Jae Kim, Seoul (KR); Jung Gyu Park, Incheon (KR); Ginny Park, Goyang-si (KR); Chun Son Lim, Seoul (KR)

(72) Inventors: Young Jae Kim, Seoul (KR); Jung Gyu Park, Incheon (KR); Ginny Park, Goyang-si (KR); Chun Son Lim, Seoul (KR)

(73) Assignee: CJ CHEILJEDANG CORPORATION, Seoul (KR)

(21) Appl. No.: 14/118,769

(22) PCT Filed: May 3, 2012
(86) PCT No.: PCT/KR2012/003477

§ 371 Date: Nov. 19, 2013

(30) Foreign Application Priority Data
May 19, 2011 (KR) 10-2011-0047178

(51) Int. Cl. A23L 1/22

(52) U.S. Cl. CPC A23L 1/22016
USPC 426/289; 426/658

(57) ABSTRACT

The present invention relates to an agglomeration-preventablea sweetener composition treated to prevent agglomeration and to a method for preparing same. More particularly, the present invention relates to an agglomeration-preventablea sweetener composition treated to prevent agglomeration by coating sweetener powder particles with dietary fiber, and to a method for preparing same.

### TECHNICAL FIELD

The present invention relates to a solidification-prevented sweetener material composition in which agglomeration is prevented, and a method for preparing the same.

### BACKGROUND ART

Sugar contains sucrose as a main component, and is one of the representative sweeteners that are added to foods and taste sweet. Depending on its raw materials, examples of sugar can include cane sugar obtained from sugar cane, and beet sugar obtained from sugar beet. In addition, sugar can include maple sugar obtained from sap extracted from sugar maple, and the like.

Sugar products are generally produced in powdery form similar to other sweeteners and flavor enhancers. Thus, sugar also suffers from a solidification phenomenon, which generally occurs during distribution of powdery products.

The solidification phenomenon refers to agglomeration of particles of powdery products by absorbing atmospheric moisture during distribution of the powdery products. As the size of particles is smaller, the area of absorbing moisture becomes wide, thereby intensifying the solidification phenomenon. Such a solidification phenomenon can deteriorate quality of products, causing inconvenience to consumers. In order to prevent such a solidification phenomenon, a method of adding and mixing silicon dioxide, pectin, starch, and the like (as a solidification preventing agent) with a sweetener material has been suggested. However, such a solidification preventing agent is only added in a small amount when the sweetener material composition is prepared, which makes it difficult for the solidification preventing agent to be uniformly distributed throughout the sweetener material composition by a simple mixing method known in the art. For this reason, there is a problem in that the solidification phenomenon of powder is not effectively inhibited.

Dietary fiber refers to high molecular carbohydrates which are known as fibroid materials or cellulose mostly contained in vegetables, fruits, seaweeds, and the like among the foods and which is not digested by human digestive enzymes and excreted from the body.

Fibroid materials are mostly contained in tough parts (cellulose) of vegetables, pectin in fruits, sticky ingredients (alginic acid) of sea mustard or kelp, and the like. Among various dietary fibers, indigestible maltodextrin (resistant maltodextrin) is difficult for persons to digest, and has a high molecular carbohydrate structure having a high degree of polymerization of carbohydrate as compared to general maltodextrin.

On the other hand, sugar is the best sweetener material for sweetness, and can be used in various foods, processed foods, and the like for improving the taste of foods and stimulating appetite. However, research has frequently reported the harmfulness of sugar that excessive consumption of sugar can cause adult diseases such as obesity, diabetes and the like, which become a serious problem. In order to overcome this problem, various sweetener materials replacing sugar are being studied, and further studies capable of inhibiting the absorption into the body even when sugar is taken have been actively performed.

Xylose is a natural sweetener found in birch, corn and the like, and has about 40% the sweetness of sugar. Xylose is known as one of diverse sweetener materials that can supplement the harmfulness of sugar by replacing sugar.

When xylose is taken together with sugar, xylose can inhibit the activity of sucrase which is a sugar digestion enzyme, thereby inhibiting digestion of sugar. As a result, sugar's absorption into the body is inhibited and sugar is discharged from the body. It is also recognized that xylose has effects of inhibiting rapid increase of blood glucose level and preventing adult diseases, such as diabetes, obesity, and the like.

Further, arabinoxylan, which is a complex polysaccharide consisting of arabinose and xylose, is a physiological active substance related to antiallergic, immune activity and anticancer action, and various study results concerning arabinoxylan have been released in recent years.

### DESCRIPTION

### Technical Problem

The present invention is aimed at providing a solidification-prevented sweetener material composition and a method of preparing the same.

In addition, the present invention is aimed at providing a solidification-prevented sweetener material composition including sugar and xylose as constitutional components to inhibit excessive sugar absorption into the human body.

### Technical Solution

The present invention provides a solidification-prevented sweetener material composition wherein particles of sweetener material powder are coated with dietary fiber, and a method of preparing the same.

The sweetener material may include all sorts of materials that taste sweet. Preferably, sugar is utilizable as the sweetener material, more preferably sugar and xylose are utilizable in combination.

Sugar is not particularly limited in view of sorts according to raw materials. One or two or more selected from white sugar, brown sugar or black sugar which is in crystalline powder form may be utilized in combination.

Although the particle size of sucrose is not particularly limited, sugar preferably has a particle size from 0 μm to 600 μm, more preferably from 0 μm to 500 μm. Still more preferably, sugar has an average particle size from 150 μm to 300 μm.

Although the particle size of xylose is not particularly limited, xylose preferably has a particle size from 0 μm to 600 μm, more preferably from 0 μm to 500 μm. Still more preferably, xylose has an average particle size from 150 μm to 350 μm.

Examples of the dietary fiber may include insoluble dietary fibers, for example, cellulose, hemicelluloses, lignin, and the like, water soluble dietary fibers, for example, pectin of fruits, vegetable gums, polysaccharides of seaweeds, and the like, or polydextrose produced by bioengineering methods, low molecular weight alginic acid, or a indigestible maltodextrin, and the like.

Among various dietary fibers, the indigestible maltodextrin has characteristic properties in that the indigestible maltodextrin is water soluble; the indigestible maltodextrin does not increase viscosity of foods when used in foods;

the indigestible maltodextrin has a higher carbohydrate structure with high polymerization degree of carbohydrates as compared to general maltodextrin, thereby having a high quality stability; and the indigestible maltodextrin is a functional material having an effect of inhibiting rapid increase of blood glucose level in the human body. Therefore, the indigestible maltodextrin is appropriate for being used in foods. As the dietary fiber which is a constitutional component of the present invention, the indigestible maltodextrin is still more preferably used.

The method for coating particles of the sweetener material powders with dietary fiber may include: 1) mixing sweetener material powders in a mixer for food preparation capable of liquid phase spray; 2) coating the mixed powder with a dietary fiber by scattering and mixing the dietary fiber with the mixed powder; and 3) drying the coated sweetener material powder mixture composition in a dryer.

The 3) drying operation is performed such that the water content is about 0.2 wt % or less based on the total weight of the composition. The solidification-prevented sweetener material composition preferably includes 95 wt % to 99.9 wt % of sweetener material and 0.1 to 5.0 wt % of dietary fiber, based on the total weight of the composition.

As the sweetener material, it is preferable to use a mixture of sugar and xylose.

The formulation ratio of sugar and xylose used as the sweetener material is not particularly limited. However, excessive introduction of xylose can affect the functionality of the sweetener material composition. In order to achieve effective inhibition of sugar absorption into the human body without affecting the functionality, the weight ratio of sugar to xylose is preferably about 1: 0.05 to 1: 0.5, more preferably about 1: 0.07 to 1: 0.2, still more preferably about 1: 0.1.

The solidification-prevented sweetener material composition according to the present invention may be used as a material for sweetener alone or in combination with one or more other food materials.

### Advantageous Effects

The solidification-prevented sweetener material composition according to the invention can prevent a solidification phenomenon during distribution and storage thereof.

Further, in case that the composition of the present invention includes sugar and xylose, xylose may inhibit sugar's absorption into the human body. As a result, the composition according to the present invention has effects of preventing rapid increase in blood glucose and adult onset diseases such as diabetes and obesity.

### Mode for Invention

Terms used herein are defined below.

The term “sweetener” as used herein refers to a generic term for seasonings to add sweetness and food additives.

The term “sweetener material” as used herein refers to a constitutional component constituting the sweetener.

The term “dietary fiber” as used herein is a component known as fibroid materials or cellulose contained mainly in vegetables, fruits, seaweeds and the like among the foods. The dietary fiber is a high molecular carbohydrate which is not digested by human digestive enzymes and discharged from the body.

The term “solidification” as used herein refers to an agglomeration phenomenon generated by moisture absorption by small particles. Such solidification can be frequently noticed in powdered products.

Hereinafter, the present invention will be described in more detail with reference to the following examples, comparative examples and comparative test examples. However, it should be understood that these examples, comparative examples and comparative test examples are provided for illustration only and are not to be in any way construed as limiting the present invention.

### EXAMPLES

### Example 1

### Preparation of Solidification-Prevented Sweetener Material Composition (Includes Sugar and Xylose)

890 g of fine sugar commercially available from CJ Cheiljedang Co., Ltd. (average particle size: about 220 μm) and 95 g of xylose were added to a mixer, followed by uniformly mixing. Subsequently, 15 g of liquid indigestible maltodextrin (65 brix) was scattered into the mixed powder, thereby uniformly coating the powder. Next, the mixed sweetener material composition was transferred to a dryer. The mixed sweetener material composition was dried through a hot air drying method so that the water content was not more than 0.2 wt % based on the total weight of the mixed sweetener material composition, thereby obtaining 1 kg of the solidification-prevented sweetener material composition containing sugar and xylose.

### Comparative Example 1

### Preparation of Sweetener Material Composition By Simply Mixing Sugar And Xylose

900 g of fine sugar commercially available from CJ Cheiljedang Co., Ltd. (average particle size: about 220 μm) and 100 g of xylose (average particle size: about 260 μm) were added to a mixer, followed by uniformly mixing. A sweetener material composition in which sugar and xylose are simply mixed was obtained so that the step of coating powder particles with dietary fiber such as a liquid indigestible maltodextrin as in Example 1 was omitted.

### Comparative Test Example 1

### Comparison Analysis for Each Sweetener Material Composition Using Particle Size Analyzer

The sweetener material compositions prepared in Example 1 and Comparative Example 1, commercially available general sugar (CJ Cheiljedang Co., Ltd., average particle size: about 455 μm) and commercially available fine sugar (CJ Cheiljedang Co., Ltd., average particle size: about 220 μm) were obtained, and compared the particle size of the four sweetener material compositions using a particle size analyzer “Standard Particle Size Analyzer” (Chunggye Corporation). As the particle size of powders is smaller, the surface area of powders absorbing moisture becomes wider, thereby enhancing powder agglomeration. Accordingly, the solidification phenomenon which is frequently noticed in powder products such as sweeteners becomes severer. In view of this point, measuring the particle size of powders could provide meaningful comparison data. The comparison results for the particle size of each sweetener material composition are shown in Table 1.

TABLE 1

| | | | | | | Fine sugar + |
|---|---|---|---|---|---|---|
| | | | | | Fine | Xylose + |
| | Particle | General | Fine | | sugar + | Indigestible |
| | size | Sugar | Sugar | Xylose | Xylose | maltodextrin |
| Mesh | (μm) | (%) | (%) | (%) | (%) | coating (%) |
| 40 | 420 | 56.3 | 0.7 | 12.6 | 1.9 | 13.0 |
| 60 | 250 | 33.5 | 67.9 | 60.0 | 67.1 | 72.0 |
| 80 | 177 | 6.4 | 16.4 | 15.7 | 16.3 | 12.0 |
| 100 | 149 | 2.5 | 7.4 | 6.1 | 7.3 | 2.0 |
| 120 | 125 | 1.1 | 4.5 | 3.1 | 4.4 | 0.5 |
| 140 | 105 | 0.2 | 1.8 | 1.2 | 1.7 | 0.2 |

| | | | | | |
|---|---|---|---|---|---|
| Average particle | 455 | 220 | 260 | 224 | 296 |
| size (μm) | | | | | |

### Comparative Test Example 2

### Comparison Analysis of Solidification Phenomenon of Sweetener Material Composition Depending on Particle Size

The sweetener material compositions prepared in accordance with Example 1 and Comparative Example 1, a commercially available general sugar (CJ Cheiljedang Co., Ltd., average particle size: about 455 μm) and a commercially available fine sugar (CJ Cheiljedang Co., Ltd., average particle size: about 220 μm) were obtained. A test for comparing the degree of solidification phenomenon generated in the four different sweetener material compositions was performed.

Testing was performed as follows. 1 kg of each of four sweetener material compositions was put into a package bag, followed by providing humidity while the package bag was open at 50° C. for 24 hours (0˜24 hours from the start of the test). Subsequently, the compositions were dried 96 hours (24˜120 hours from the start of the test) while the degree of solidification of each sweetener material composition was observed for 24 hours. The comparison results of the degree of solidification are summarized in Table 2.

TABLE 2

| | | | | Fine sugar + |
|---|---|---|---|---|
| | | | | Xylose + |
| | | | | Indigestible |
| | | | | maltodextrin |
| | General Sugar | Fine Sugar | Fine sugar + Xylose | coating |
| Initiate | Good | Good | Good | Good |
| (Hygroscopic) | | | | |
| After 24 hours | Good | Good | Good | Good |
| (dry) | | | | |
| After 48 hours | Solidification | Weak | Weak | Solidification |
| (dry) | initiated | solidification | solidification initiated at | initiated at exposed |
| | at exposed portion | initiated at | exposed portion | portion |
| | | exposed | | |
| | | portion | | |
| After 72 hours | Weak | Solidified | Solidification Expansion | Weak |
| (dry) | solidification | | at exposed portion | solidification |
| | initiated at | | | initiated at exposed |
| | exposed portion | | | portion |
| After 96 hours | Solidification | Solidified | Solidified | Weak solidification |
| (dry) | Expansion at | | | initiated at exposed |
| | exposed portion | | | portion |
| After 120 | Solidified | Solidified | Solidified | Solidification |
| hours (dry) | | | | Expansion at |
| | | | | exposed portion |

In Table 2, the term “good” represents that the powder state directly after opening of the package bag was maintained (the degree of solidification based on the total powder is approximately 0%). The term “solidification initiated” represents the powder state that the surface of powder exposed by opening the package bag started to solidify (within about 10% of degree of solidification). The term “weak solidification” represents the powder state that powder about 2 cm below the exposed surface of powder was solidified (about 20% degree of solidification). The term “solidification expansion” represents the powder state that weak solidification has been conducted throughout the powder (about 40% of degree of solidification). The term “solidified” represents the powder state that strong solidification occurred throughout the powder (about 80% of degree of solidification).

As the result of comparison analysis for degree of solidification, it was found that all the sweetener material compositions initiated solidification 48 hours after start of testing. The solidification phenomenon that could be problematic in powder products was noticed first in the fine sugar having the smallest particle size.

On the basis of particle size, it can be expected that general sugar (average particle size: about 455 μm) having the largest particle size would begin to solidify the latest. However, from results of testing, it was observed that the sweetener material composition (average particle size: about 296 μm) prepared in Example 1 having a particle size smaller than that of the general sugar solidified the latest. It was determined that this was because particles were coated with indigestible maltodextrin, which prevented agglomeration of sweetener material particles due to water absorption and temperature increase.

### Example 2

### Preparation of Solidification-Prevented Sweetener Material Composition (Including Sugar And Xylose) According to Preferable Compositional Ratio

In mixing sugar with xylose, sugar and xylose were mixed in a weight ratio of about 10:1 as shown in Table 3 as a desirable formulation ratio in order to achieve effective inhibition of sugar's absorption into the human body without affecting the functionality of the sweetener material composition (Fine sugar—CJ Cheiljedang Co., Ltd., average particle size: about 220 μm, Xylose—average particle size: about 260 μm).

Subsequently, in order to determine the content of suitable indigestible maltodextrin such that sugar and xylose in a unit wherein sugar and xylose were uniformly mixed could be coated when coating the sweetener material composition mixed in the aforementioned formulation ratio, five samples in which the content of sugar, xylose and indigestible maltodextrin was adjusted as shown in Table 3 were prepared, followed by testing to measure time required to dry each sample and the content of xylose per 100 g of dried sweetener material composition.

TABLE 3

| | | | | | Content of |
|---|---|---|---|---|---|
| | | | | | xylose per |
| | | | Indigestible | Drying | 100 g of |
| | Fine sugar | Xylose | maltodextrin | Time | composition |
| | (%) | (%) | (%) | (min) | (g) |
| Formulation | 89.5 | 10.0 | 0.5 | 25 | 8.00 |
| Ratio (%) | 89.5 | 9.5 | 1.0 | 35 | 9.20 |
| | 89.0 | 9.5 | 1.5 | 40 | 9.45 |
| | 89.0 | 9.0 | 2.0 | 50 | 8.95 |
| | 86.5 | 8.5 | 5.0 | 120 | 8.40 |

As the result of testing, it was found that the preferred sample in which coating was conducted so that the composition powder had uniform quality and which was excellent in view of process efficiency due to short drying time had the formulation ratio including 89.0 wt % of sugar, 9.5 wt % of xylose and 1.5 wt % of indigestible maltodextrin based on the total weight of the sweetener material composition.

1. A method of preparing a solidification-prevented sweetener material composition, comprising:
coating a sweetener material with dietary fiber by adding the dietary fiber to sweetener material and mixing the sweetener material with dietary fiber.

2. The method of preparing a solidification-prevented sweetener material composition according to claim 1, wherein the dietary fiber is indigestible maltodextrin.

3. A solidification-prevented sweetener material composition prepared by the method according to claim 1 or 2.

4. The solidification-prevented sweetener material composition according to claim 3, comprising: 95 wt % to 99.9 wt % of the sweetener material and 0.1 wt % to 5.0 wt % of the dietary fiber based on a total weight of the sweetener material composition.

5. The solidification-prevented sweetener material composition according to claim 4, wherein the sweetener material is a mixture of sugar and xylose.

6. The solidification-prevented sweetener material composition according to claim 5, wherein sugar and xylose are mixed in a weight ratio of 1:0.05 to 1:0.5.
